(19) United States
(12) Patent Application Publication
(10) Pub. No.: US 2023/0157917 A1
(43) Pub. Date: May 25, 2023

(54) LUMBAR TRACTION TABLE

(71) Applicant: Jiangsu Mingteng Health Products Co., Ltd, Yancheng (CN)

(72) Inventor: Chuankui Du, Jinshan (CN)

(73) Assignee: Jiangsu Mingteng Health Products Co., Ltd, Yancheng (CN)

(21) Appl. No.: 18/073,585

(22) Filed: Dec. 2, 2022

(30) Foreign Application Priority Data
Sep. 15, 2022 (CN) 202222447191.9

(51) Int. Cl. A61G 13/00

(52) U.S. Cl. CPC A61G 13/009; A61G 2210/10

(57) ABSTRACT

The present disclosure is applicable to the field of medical apparatuses, and provides a lumbar traction table. The lumbar traction table includes a table top. An upper part of the table top is provided with a leg clamping support; the leg clamping support includes leg airbags and airbag supports. The airbag supports include a left airbag support, a middle airbag support and a right airbag support; and the airbag supports protrude from an upper surface of the table top corresponding to patient's leg. An appropriate space is reserved between the left airbag support and the middle airbag support, and an appropriate space is reserved between the right airbag support and the middle airbag support.

### TECHNICAL FIELD

The present disclosure relates to the field of medical apparatuses, specifically to a lumbar traction table.

### BACKGROUND

Various forms of lumbar traction have been described. Since the time of Hippocrates, for reducing pressure on the discs in the lower back to reduce pain, lumbar traction is a treatment option that is based on the application of a longitudinal force to the axis of the spinal column in the lower back. In other words, parts of the lumbar columns are pulled in opposite directions to stabilize or change the position of damaged aspects of the lumbar.

Most of common existing traction tables include a mobile half side and a stationary half side. A thoracic or chest belt is installed on the stationary half side and a pelvic belt or ankle belt is installed on the mobile half side, to immobilize the patient's chest, pelvis and ankles. The fixing method of the thoracic, chest belt, pelvic belt and ankle belt is very clumsy and inconvenient. It is difficult for patients who suffer from lumbar disc disease to move and sit up. These patients often feel painful in the hips and legs when they are sitting up and bending over. When those patients use a home lumbar traction table, it will be very painful and inconvenient for themselves to tie up the chest belt, pelvic belt and ankle belt.

In addition, a gravity lumbar traction method is also popular in the market. The gravity lumbar traction normally uses a chest harness to secure the patient as the treatment table is tilted to a vertical position, thereby using the weight of the lower half of the body to provide a traction force. The patient is simply unable to put on the chest harness by himself. Meanwhile, by the gravity traction method, it is very hard to accurately control the traction distance and traction strength.

### SUMMARY

The present disclosure discloses a system which solves or at least substantially reduces the impact of these problems associated with existing lumbar traction tables.

It is one object and advantage of the present disclosure to provide a lumbar traction table which patients no longer need to tie up or wear any thoracic belt, chest belt, pelvic belt, ankle belt, or chest harness.

It is another object and advantage of the present disclosure to provide a lumbar traction table which patients do not need complex preparations, just lie down on the lumbar traction table to start the lumbar traction.

It is still another object and advantage of the present disclosure to provide a lumbar traction table which the traction distance and traction strength can be accurately controlled.

It is an additional object and advantage of the present disclosure to provide a lumbar traction table which patients can use it at home by themselves and control it very conveniently.

It is yet another object and advantage of the present disclosure to provide a lumbar traction table which can be used for people of different heights.

The above and other objects, advantages and features of the present disclosure will become more readily appreciated and understood from a consideration of the following detailed description of preferred embodiments of the present disclosure when taken together with the accompanying drawings of the present disclosure.

The present disclosure is achieved by a lumbar traction table. The lumbar traction table includes:

A table top, an upper portion of which is provided with a leg clamping support.

The leg clamping support includes a left airbag support, a middle airbag support and a right airbag support; the leg clamping support protrudes from the upper surface of the table top that corresponds patient's legs.

An appropriate space is reserved between the left airbag support and the middle airbag support; and an appropriate space is reserved between the right airbag support and the middle airbag support. The left leg and right leg of the patient can be placed in the above two spaces.

The mounting position of the middle airbag support is in between the two legs of the patient; airbags are installed on the right side of the left airbag support, the left side of the right airbag support and both sides of the middle airbag support.

A fixed support is mounted below the table top; a sliding support frame is arranged below the leg clamping support; a sliding guide rail is arranged at a portion of the sliding support frame that is in contact with the fixed support; the sliding guide rail is parallel to the direction of the table top; and the sliding support frame drives the left airbag support, the middle airbag support and the right airbag support to move back and forth along the sliding guide rail.

In a further technical solution, below the table top, an actuator for driving the sliding support frame is mounted between the sliding support frame and the fixed support; and the actuator extends and retracts to enable the sliding support frame to move back and forth along the sliding guide rail.

In a further technical solution, the leg airbags are flat when un-inflated; and the leg airbags are bulged when inflated. When the airbags are inflated, the airbags clamp both legs of the patient.

In a further technical solution, an upper body fixing assembly is further arranged on the table top; and the upper body fixing assembly is symmetrically mounted on two sides corresponding to the upper body of the patient to fix the upper body of the patient.

In a further technical solution, the lumbar traction table further includes air pumps and air valves; the air pumps are connected to the air valves through air inlet and outlet hoses; the air pumps supply air to the air valves through the air inlet and outlet hoses; the air valves are connected to the leg airbags through the air inlet and outlet hoses; and the leg airbags are inflated or deflated through the air inlet and outlet hoses.

In a further technical solution, the lumbar traction table further includes a circuit board and a transformer; the transformer is connected to an external power supply; the transformer is connected to the circuit board through a wire and supplies power to the circuit board; and the circuit board is connected to the air pumps and the air valves through wires and supplies power to the air pumps and the air valves, thus forming a complete power supply loop.

In a further technical solution, the circuit board is connected to the actuator through a wire; and the circuit board supplies power to the actuator through the wire.

In a further technical solution, a push force from the actuator to the sliding support frame is not greater than 25 kg.

In a further technical solution, the lumbar traction table further includes a controller; the controller is connected to the circuit board through a wire; the controller is provided with buttons; and the buttons are in communication connection with the circuit board through wires.

In a further technical solution, the circuit board pre-stores a working program; and the circuit board controls working states of the air pumps, the air valves and the actuator according to the preset program.

Compared with the prior art, the present disclosure has the beneficial effects:

A patient can directly lie on the table, put one leg in the space between the left airbag support and the middle airbag support, put another leg in the space between the right airbag support and the middle airbag support. The patient commands, through the buttons of the controller, the leg airbags to be inflated to clamp the legs of the patient. The actuator is controlled to push the sliding support frame, the leg clamping support together with the patient's leg to move towards a direction away from the waist of the patient, thus achieving a lumbar traction effect.

### BRIEF DESCRIPTION OF THE DRAWINGS

The following figures are schematic representations of the present disclosure:

FIG. 1 is a flat view of a lumbar traction table provided according to an embodiment of the present disclosure;

FIG. 2 is a top view of a lumbar traction table provided according to an embodiment of the present disclosure;

FIG. 3 is a three-dimensional exploded diagram of a lumbar traction table provided according to an embodiment of the present disclosure;

FIG. 4 is a three-dimensional front view of a lumbar traction table provided according to an embodiment of the present disclosure; and

FIG. 5 is a three-dimensional back view of a lumbar traction table provided according to an embodiment of the present disclosure.

In the drawings: 1: table top; 2: sliding support frame; 2-1: left airbag support; 2-2: middle airbag support; 2-3: right airbag support; 3: leg airbag; 4: air inlet and outlet hose; 5: fixed support; 6: guide rail; 7: actuator; 8: air pump; 9: air valve; 10: circuit board; 11: transformer; 12: controller; 12-1: button; 13: axilla support bar; and 14: chest clamping airbag.

### DETAILED DESCRIPTION OF THE EMBODIMENTS

In order to make the objectives, technical solutions and advantages of the present disclosure clearer, the present disclosure is further describable in detail below with reference to accompanying drawings and embodiments. It should be understood that the specific embodiments describable here are merely to illustrate and explain the present disclosure, and not intended to limit the present disclosure.

Specific implementations of the present disclosure are describable in detail below in combination with specific embodiments.

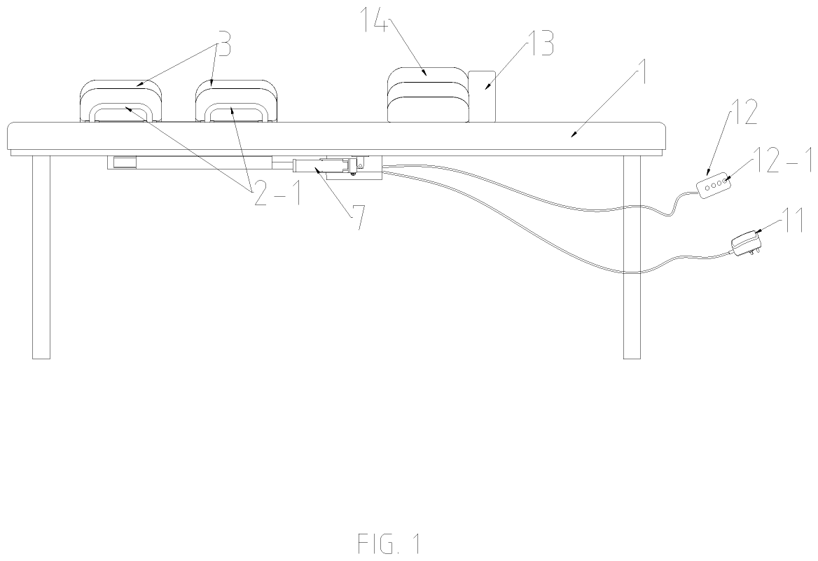

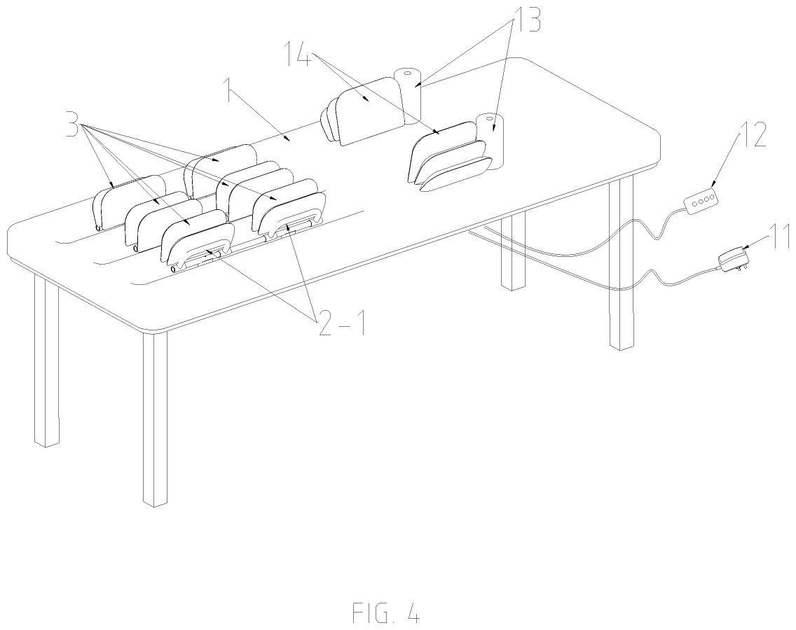

As shown in FIG. 1 to FIG. 4, a lumbar traction table provided according to one embodiment of the present disclosure includes a table top 1, a sliding support frame 2 and leg airbags 3. Positions of the table top 1 corresponding to the legs of a patient are provided with three hollowed grooves. The sliding support frame 2 is provided with a left airbag support 2-1, a middle airbag support 2-2 and a right airbag support 2-3. The left airbag support 2-1, the middle airbag support 2-2 and the right airbag support 2-3 respectively pass through the three hollowed grooves of the table top 1, and protrude from an upper surface of the table top 1. The left airbag support 2-1 is provided with a leg airbag 3 towards the middle airbag support 2-2. The right airbag support 2-3 is provided with a leg airbag 3 towards the middle airbag support 2-2. The middle airbag support 2-2 is provided with leg airbags 3 respectively towards the left airbag support 2-1 and the right airbag support 2-3. The paired face-to-face arrangement of the airbags 3 allow the airbags to clamp the patient's left and right legs. The leg airbags 3 correspond to patient's legs. The leg airbags 3 will clamp patient's left and right legs when the airbags 3 are inflated with air.

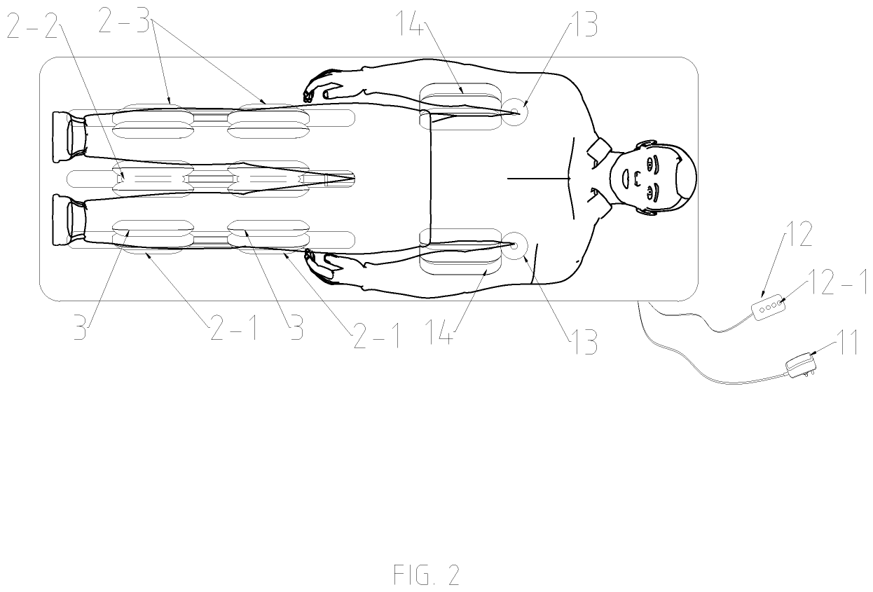

As shown in FIG. 2, an appropriate space is reserved between the left airbag support 2-1 and the middle airbag support 2-2. An appropriate space is reserved between the right airbag support 2-3 and the middle airbag support 2-2. The legs of the patient are placed in the spaces.

As shown in FIG. 1 to FIG. 4, chest clamping airbags 14 are arranged on two sides of a position of the table top 1 corresponding to the chest of the patient. Axilla support bars 13 are arranged at positions corresponding to the two axilla of the patient. The chest clamping airbags 14 and the axilla support bars 13 achieve an effect of fixing the upper body of the patient.

As shown in FIG. 1 to FIG. 4, each leg airbag 3 and each chest clamping airbag 14 are both provided with the air inlet and outlet hose 4.

In the present disclosure, the leg airbags 3 and the chest clamping airbags 14 can be inflated or deflated through the air inlet and outlet hoses 4.

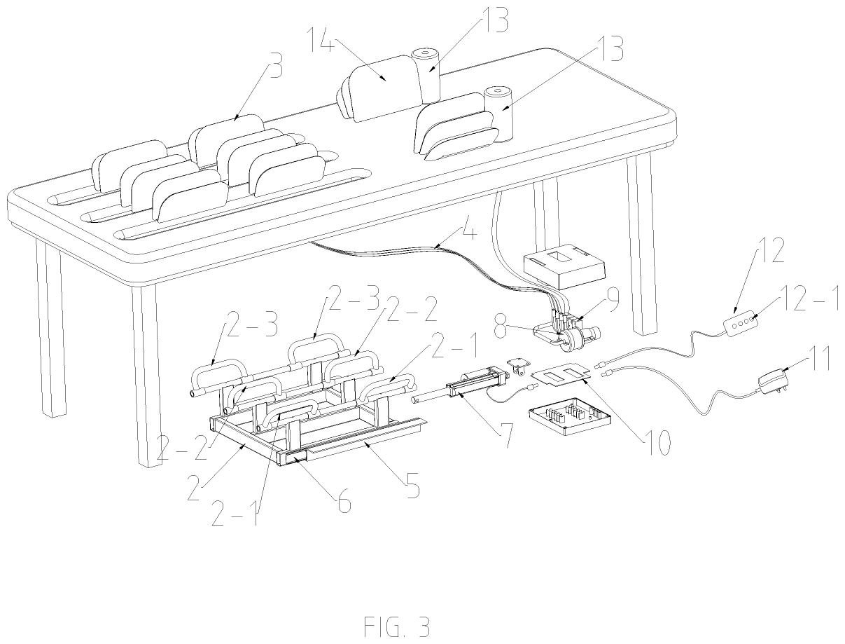

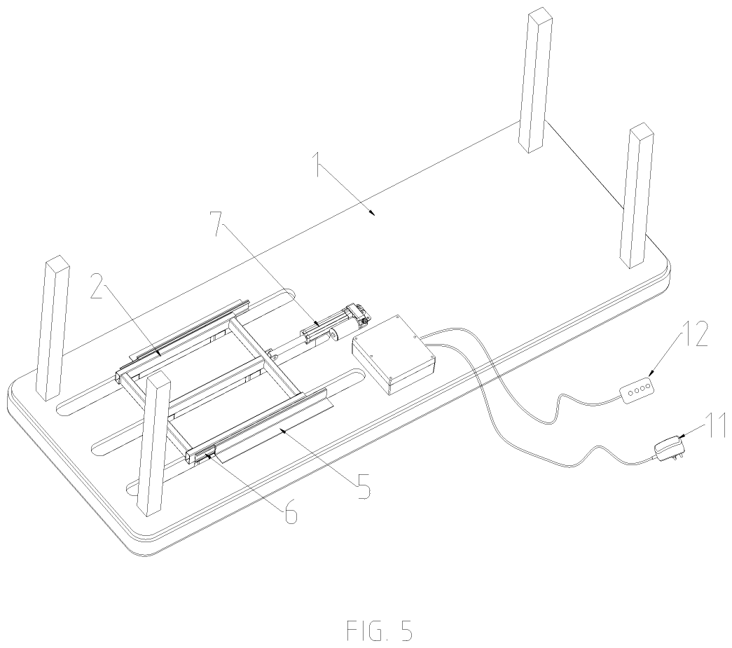

As shown in FIG. 1, FIG. 3 and FIG. 5, a fixed support 5 is mounted below the table top 1. The fixed support 5 is fixed to a lower surface of the table top 1. A guide rail 6 is arranged at a portion of the sliding support frame 2 that is in contact with the fixed support 5. The guide rail 6 is connected to the fixed support 5 and the sliding support frame 2 respectively. The guide rail 6 is parallel to a direction of the table top 1. The sliding support frame 2 may move back and forth along the guide rail 6 and the table top 1.

As shown in FIG. 1, FIG. 3 and FIG. 5, an actuator 7 is mounted below the table top 1. One end of the actuator 7 is connected to the sliding support frame 2. The actuator 7 may extend and retract to push and pull the sliding support frame 2 to move back and forth along the guide rail 6.

In the present disclosure, a push force from the actuator 7 to the sliding support frame 2 is not greater than 25 kg, so as to avoid lumbar spine injury to the patient caused by extremely high lumbar traction strength to the patient.

As shown in FIG. 3, the lumbar traction table further includes air pumps 8 and air valves 9. The air pumps 8 are connected to the air valves 9 through the air inlet and outlet hoses 4. The air pumps 8 supply air to the air valves 9 through the air inlet and outlet hoses 4. The air valves 9 are connected to the leg airbags 3 through the air inlet and outlet hoses 4. The leg airbags 3 are inflated, held and deflated through opening, closing and air release functions of the air valves 9, thus forming a complete air loop.

As shown in FIG. 3, the air valves 9 are connected to the chest clamping airbags 14 through the air inlet and outlet hoses 4. The chest clamping airbags 14 are inflated, held and deflated through the opening, closing and air release functions of the air valves 9, thus forming another complete air loop.

In the present disclosure, when a patient lays in a supine or prone position on the upper surface of the table top 1, the patient can put one leg in the space between the left airbag support 2-1 and the middle airbag support 2-2 and put another leg in the space between right airbag support 2-3 and the middle airbag support 2-2. The patient clamps the axilla support bars 13 with the axilla. The actuator 7 extends and retracts to drive the sliding support frame 2 to move. The left airbag support 2-1, the middle airbag support 2-2 and the right airbag support 2-3 of the sliding support frame 2 are adjusted to a position where the patient feels comfortable. The air pumps 8 supply air to the air valves 9. The air valves 9 supply air to the leg airbags 3 and the chest clamping airbags 14. After being inflated, the leg airbags 3 swell to clamp the left leg and the right leg of the patient. After being inflated, the chest clamping airbags 14 swell to clamp the chest of the patient. At this time, the actuator 7 pushes the sliding support frame 2 to move towards a direction away from the waist of the patient. The sliding support frame 2 drives the left airbag support 2-1, the middle airbag support 2-2, the right airbag support 2-3 and the leg airbags 3 to clamp the legs of the patient to move towards a direction away from the waist of the patient. The axilla support bars 13 and the chest clamping airbags 14 achieve an effect of fixing the upper body of the patient to prevent the upper body of the patient from moving, thus achieving the lumbar traction for the patient.

As shown in FIG. 3, the embodiment of the present disclosure is further equipped with a transformer 11. A circuit board 10 is mounted below the table top 1. The transformer 11 is connected to an external power supply. The transformer 11 can be connected to an external power supply socket and convert a high voltage of 110-230 V of the external power supply into a safe voltage lower than 36 V. The transformer 11 is connected with the circuit board 10 through a wire and supplies power to the circuit board 10. The circuit board 10 is connected to the air pumps 8 and the air valves 9 through wires and supplies power to the air pumps 8 and the air valves 9, thus forming a complete power supply loop.

As shown in FIG. 3, the circuit board 10 is connected to the actuator 7 through a wire. The circuit board 10 supplies power to the actuator 7 through a wire.

In the present disclosure, the circuit board 10 pre-stores a working program. By means of powering on or powering off the air pumps 8 or the air valves 9 according to the pre-stored program, the circuit board 10 controls the air pumps 8 to pump air or controls the opening, closing and air release of the air valves 9, thus inflating, holding and deflating the leg airbags 3 and the chest clamping airbags 14. The circuit board 10 controls, according to the pre-stored program by means of supplying power to the actuator 7, the actuator 7 to extend and retract.

As shown in FIG. 1, FIG. 3 and FIG. 5, the lumbar traction table further includes a controller 12. The controller 12 is connected with the circuit board 10 through a wire. The controller 12 is provided with buttons 12-1. The buttons 12-1 are in communication connection with the circuit board 10 through a wire. The circuit board 10 is controlled by means of controlling the buttons 12-1.

In the present disclosure, when the patient lays in a supine or prone position on the upper surface of the table top 1, the patient can put one leg in the space between the left airbag support 2-1 and the middle airbag support 2-2 and put another leg in the space between right airbag support 2-3 and the middle airbag support 2-2. The patient clamps the axilla support bars 13 with the axilla. The patient operates the buttons 12-1 of the controller 12 to instruct the circuit board 10 to start to work. The circuit board 10 supplies power to the air pumps 8 according to the pre-stored working program, so that the air pumps 8 start to pump air, and the pumped air is conveyed to the air valves 9 through the air inlet and outlet hoses 4. The air valves 9 supply air to the leg airbags 3 and the chest clamping airbags 14. After being inflated, the leg airbags 3 swell to clamp the left leg and the right leg of the patient. After being inflated, the chest clamping airbags 14 swell to clamp the chest of the patient. At this time, the circuit board 10 supplies power to the actuator 7 according to the program, so that the actuator 7 pushes the sliding support frame 2 to move towards a direction away from the waist of the patient. The sliding support frame 2 drives the left airbag support 2-1, the middle airbag support 2-2, the right airbag support 2-3 and the leg airbags 3 to clamp the legs of the patient to move towards a direction away from the waist of the patient. The axilla support bars 13 and the chest clamping airbags 14 achieve an effect of fixing the upper body of the patient to prevent the upper body of the patient from moving, thus achieving the lumbar traction for the patient.

In the present disclosure, the patient can control an extend-retract length and extend-retract strength of the actuator 7 through the buttons 12-1 of the controller 12, thus controlling a traction length and traction strength.

In the present disclosure, after the traction is completed, the circuit board 10 stops supplying power to the air valves 9 according to the pre-stored working program, so that the air valves 9 release air to deflate the leg airbags 3 and the chest clamping airbags 14. The leg airbags 3 and the chest clamping airbags 14 are flat after being deflated, and will no longer clamp the legs and the chest of the patient. The circuit board 10 controls, according to the pre-stored working program, the actuator 7 to pull the sliding support frame 2 to move towards the waist of the patient, thus, the sliding support frame 2, the left airbag support 2-1, the middle airbag support 2-2 and the right airbag support 2-3 can be restored to their original positions.

In the present disclosure, the patient turns on the traction function of the present disclosure through the button 12-1 of the controller 12, and sets a traction distance and traction strength by means of controlling the button 12-1. The circuit board 10 performs traction on the lumbar spine of the patient according to the pre-stored working program and resets the sliding support frame 2, repeatedly for multiple times, to achieve multiple tractions on the lumbar spine of the patient.

The above descriptions are only the preferred embodiments of the present disclosure, and are not intended to limit the present disclosure. Any modifications, equivalent replacements and improvements that are made within the spirit and principle of the present disclosure shall fall within the protection scope of the present disclosure.

What is claimed is:

1. A lumbar traction table, comprising a table top, wherein an upper part of the table top is provided with a leg clamping support; the leg clamping support comprises leg airbags and airbag supports;
the airbag supports comprise a left airbag support, a middle airbag support and a right airbag support; the airbag supports protrude from an upper surface of the table top corresponding to patient's legs; an appropriate space is reserved between the left airbag support and the middle airbag support, and an appropriate space is reserved between the right airbag support and the middle airbag support; the left leg and right leg of the patient can be placed in above two spaces;
the mounting position of the middle airbag support is in between the two legs of the patient; airbags are installed on the right side of the left airbag support, the left side of the right airbag support and both sides of the middle airbag support;
a fixed support is mounted below the table top; a sliding support frame is arranged below the leg clamping support; a sliding guide rail is arranged at a portion of the sliding support frame that is in contact with the fixed support; the sliding guide rail is parallel to the direction of the table top; and the sliding support frame drives the left airbag support and the middle airbag support and right airbag support to move back and forth along the sliding guide rail.

2. The lumbar traction table according to claim 1, wherein an actuator for driving the sliding support frame is mounted between the sliding support frame and the fixed support; and the actuator extends and retracts to enable the sliding support frame to move back and forth along the sliding guide rail.

3. The lumbar traction table according to claim 1, wherein the leg airbags are flat when uninflated; and the leg airbags are bulged when inflated; when the leg airbags are inflated, the leg clamping support clamps the patient's both legs.

4. The lumbar traction table according to claim 1, wherein an upper body fixing assembly for fixing the upper body of the patient is further arranged on the table top, and the upper body fixing assembly is symmetrically mounted on two sides corresponding to the upper body of the patient to fix the upper body of the patient.

5. The lumbar traction table according to claim 1, further comprising air pumps and air valves, wherein the air pumps are connected to the air valves through air inlet and outlet hoses; the air pumps supplies air to the air valves through the air inlet and outlet hoses; the air valves are connected to the leg airbags through the air inlet and outlet hoses; and the leg airbags are inflated or deflated through the air inlet and outlet hoses.

6. The lumbar traction table according to claim 1, further comprising a circuit board and a transformer, wherein the transformer is connected to an external power supply; the transformer is connected to the circuit board through a wire and supplies power to the circuit board; and the circuit board is connected to the air pumps and the air valves through wires and supplies power to the air pumps and the air valves to form a complete power supply loop.

7. The lumbar traction table according to claim 6, wherein the circuit board is connected to the actuator through a wire; and the circuit board supplies power to the actuator through a wire.

8. The lumbar traction table according to claim 7, wherein a push force from the actuator to the sliding support frame is not greater than 25 kg.

9. The lumbar traction table according to claim 6, further comprising a controller, wherein the controller is connected to the circuit board through a wire; the controller is provided with buttons; and the buttons are in communication connection with the circuit board through a wire.

10. The lumbar traction table according to claim 6, wherein the circuit board pre-stores a working program used for controlling working states of the air pumps, the air valves and the actuator.
